(19) United States
(12) Patent Application Publication
(10) Pub. No.: US 2026/0229746 A1
(43) Pub. Date: Aug. 6, 2026

(54) Flexible Busbar

(71) Applicant: Yazaki Corporation, Tokyo (JP)

(72) Inventors: Daiki Kobayashi, Shizuoka (JP); Mizuki Shirai, Shizuoka (JP)

(21) Appl. No.: 19/451,565

(22) Filed: Jan. 16, 2026

(30) Foreign Application Priority Data
Feb. 3, 2025 (JP) 2025-015887

(51) Int. Cl. H01M 50/588; H01M 50/503; H01M 50/591

(52) U.S. Cl. CPC H01M 50/588; H01M 50/503; H01M 50/591

(57) ABSTRACT

A flexible busbar includes a pair of terminal portions that are conductive terminals or busbars; an electric wire portion including a plurality of conductor portions electrically connecting between the pair of terminal portions, the plurality of conductor portions being arranged in parallel in a parallel direction which is a direction orthogonal to an axial direction of the electric wire portion and having flexibility allowing the conductor portion to be bent independently; and an insulating portion that is an insulator surrounding the plurality of conductor portions of the electric wire portion such that each of the plurality of conductor portions is allowed to be bent independently.

### CROSS-REFERENCE TO RELATED APPLICATIONS

This application is based on and claims priority under 35 USC 119 from Japanese Patent Application No. 2025-015887 filed on February 3, 2025, the contents of which are incorporated herein by reference.

### TECHNICAL FIELD

The present disclosure relates to a flexible busbar.

### BACKGROUND ART

For example, in an electric vehicle, a plurality of battery modules are mounted on a battery pack serving as a power source, and these battery modules are electrically connected by using high-voltage electric wires or busbars. When the busbar is a long component, a dimensional tolerance during manufacturing such as bending processing becomes stringent, and thus, in a case in which the dimensional tolerances of various portions of the busbar accumulate in an upper limit direction, a position of a connection fixing component of the busbar to a predetermined arrangement position may not align with a position of a connection portion of the arrangement position to the busbar. In this case, there is a possibility that the busbar is not assembled to the predetermined arrangement position. In addition, since the busbar is a rigid component, unnecessary stress may be applied to the connection fixing component due to swinging generated after the assembly of the vehicle. There is a structure in which the dimensional tolerance of the busbar is absorbed and the stress applied to the connection fixing component is relaxed, and the absorption of the dimensional tolerance and the relaxation of the stress are performed by using a flexible flat electric wire and bending the flat electric wire (Patent Literatures 1 and 2). There is also a structure (Patent Literature 3) in which a flexible busbar in which terminals are connected by a braided electric wire is used, and the braided electric wire is bent to absorb a dimensional tolerance and relax stress.

### Citation List

### Patent Literature

Patent Literature 1: JP2023-55393A

Patent Literature 2: JP2021-163701A

Patent Literature 3: JP2022-95191A

### SUMMARY OF INVENTION

However, the flat electric wires according to Patent Literatures 1 and 2 are likely to be bent in flatwise bending which is bending in a thickness direction, but are less likely to be bent in edgewise bending which is bending in a width direction and in which a large path difference occurs between an inner side and an outer side in the bending direction. The flat electric wires according to Patent Literatures 1 and 2 have a problem of poorer heat dissipation performance as compared with a busbar. Furthermore, the structure according to Patent Literature 1 has a problem that tolerances in a longitudinal direction cannot be absorbed. Meanwhile, a structure using a braided electric wire as in Patent Literature 3 also has a problem of poorer heat dissipation performance as compared with a busbar.

The present disclosure has been made to solve such a problem, and an object thereof is to provide a flexible busbar that can be easily bent at a bendable portion regardless of a bending direction and has excellent heat dissipation performance.

A flexible busbar of the present disclosure includes a pair of terminal portions that are conductive terminals or busbars; an electric wire portion including a plurality of conductor portions electrically connecting between the pair of terminal portions, the plurality of conductor portions being arranged in parallel in a parallel direction which is a direction orthogonal to an axial direction of the electric wire portion and having flexibility allowing the conductor portion to be bent independently; and an insulating portion that is an insulator surrounding the plurality of conductor portions of the electric wire portion such that each of the plurality of conductor portions is allowed to be bent independently.

According to the present disclosure, it is possible to provide a flexible busbar that can be easily bent at a bendable portion regardless of a bending direction and has excellent heat dissipation performance.

### BRIEF DESCRIPTION OF DRAWINGS

FIG. 1 is a perspective view illustrating a flexible busbar according to a first embodiment of the present disclosure;

FIG. 2 is an exploded perspective view of FIG. 1;

FIG. 3 is a view taken along a direction of an arrow A in FIG. 1 (as viewed in a Y direction);

FIG. 4 is a cross-sectional view taken along line B-B in FIG. 1, in which illustration of individual wires constituting a stranded wire is omitted;

FIG. 5 is a view of the vicinity of a terminal illustrated in FIG. 1 taken along a direction of an arrow C (as viewed in an X direction);

FIG. 6A and FIG. 6B are views taken along the direction of the arrow C in FIG. 1, in which FIG. 6A is a diagram illustrating a state in which a conductor portion is bent, and FIG. 6B is a modification of FIG. 6A;

FIG. 7A and FIG. 7B are views taken along a direction of an arrow D in FIG. 1 (as viewed in a Z direction), in which FIG. 7A is a diagram illustrating a state in which conductor portions are bent, and FIG. 7B is a modification of FIG. 7A;

FIG. 8 is a modification of FIG. 2;

FIG. 9 is a modification of FIG. 4;

FIG. 10 is a perspective view illustrating a flexible busbar according to a second embodiment of the present disclosure; and

FIG. 11 is a cross-sectional view taken along line E-E in FIG. 10, in which illustration of individual wires constituting a stranded wire is omitted.

### DESCRIPTION OF EMBODIMENTS

Hereinafter, the present disclosure will be described with reference to preferred embodiments. The present disclosure is not limited to the embodiments to be described below, and the embodiments can be appropriately changed without departing from the gist of the present disclosure. In the embodiments to be described below, there may be parts in which illustration and description of a part of a configuration are omitted, and it is needless to say that a public or well-known technique is appropriately applied to details of an omitted technique within a range in which no contradiction with contents to be described below would occur.

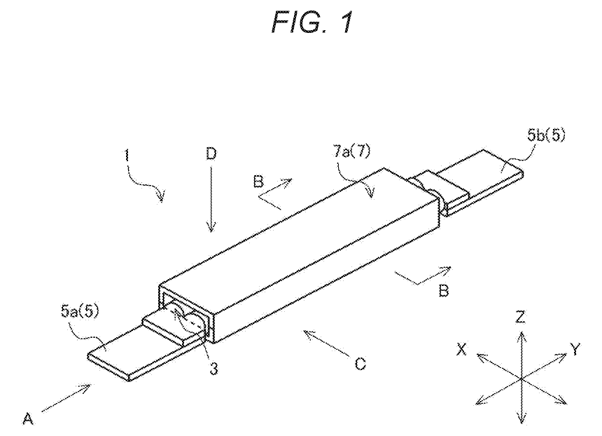

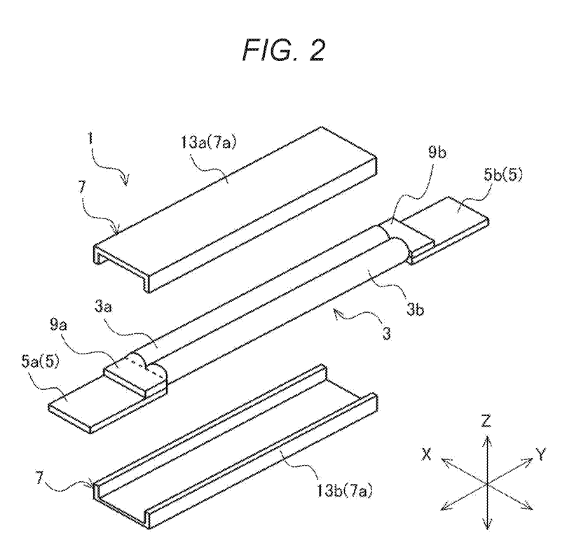

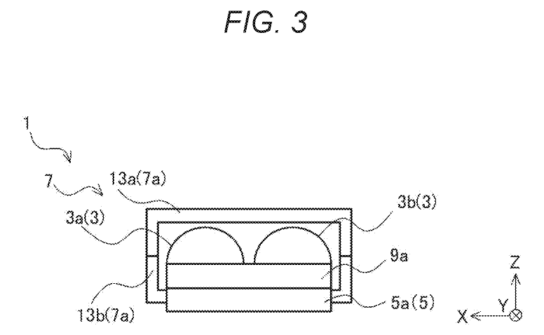

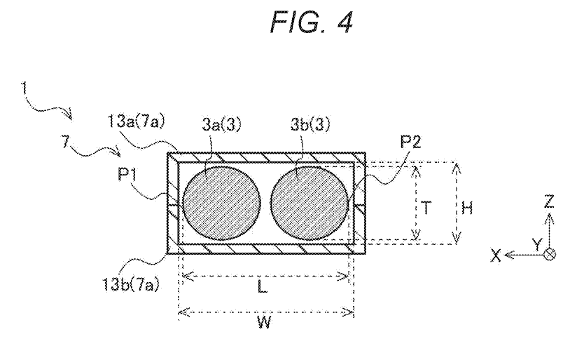

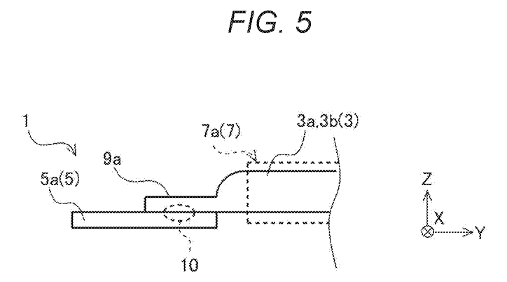

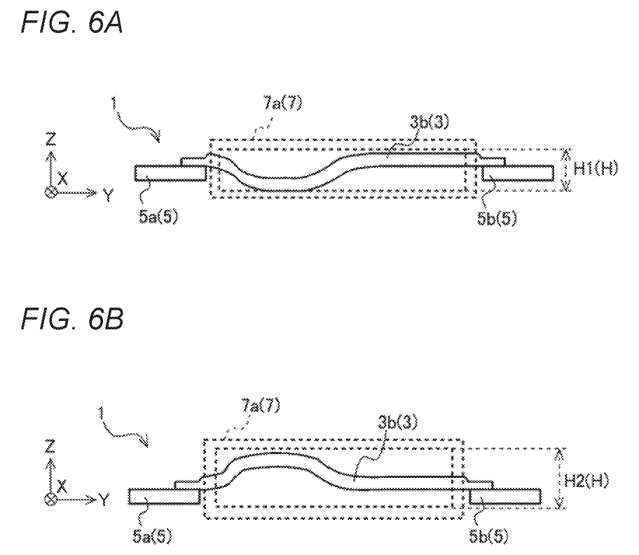

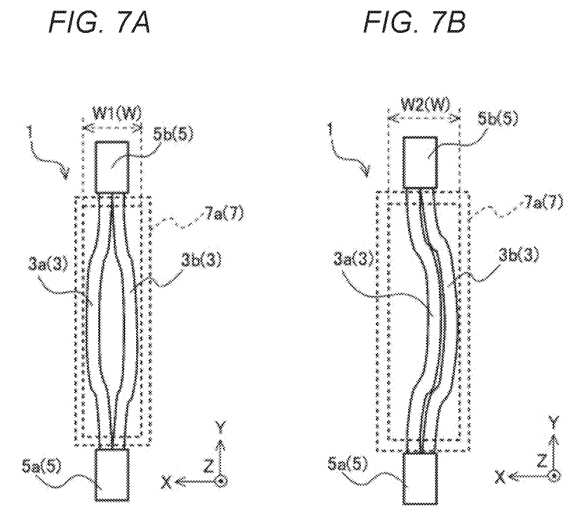

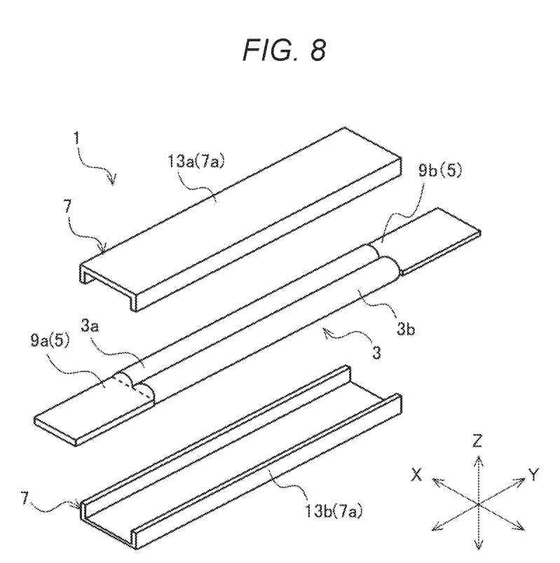

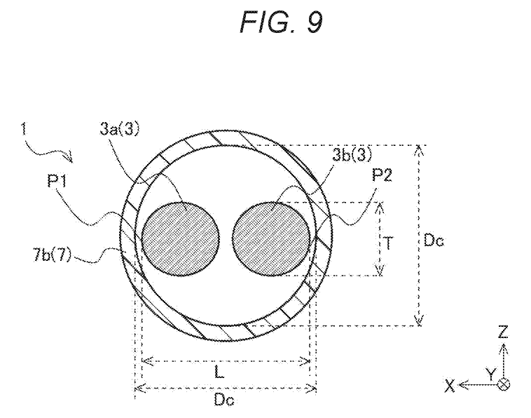

First, a configuration of a flexible busbar according to a first embodiment will be described with reference to FIGS. 1 to 9. FIG. 1 is a perspective view illustrating the flexible busbar according to the first embodiment of the present disclosure. FIG. 2 is an exploded perspective view of FIG. 1. FIG. 3 is a view taken along a direction of an arrow A in FIG. 1 (as viewed in a Y direction). FIG. 4 is a cross-sectional view taken along line B-B in FIG. 1, in which illustration of individual wires constituting a stranded wire is omitted. FIG. 5 is a view of the vicinity of a terminal illustrated in FIG. 1 taken along a direction of an arrow C (as viewed in an X direction). FIG. 6A and FIG. 6B are views taken along the direction of the arrow C in FIG. 1, in which FIG. 6A is a diagram illustrating a state in which a conductor portion is bent, and FIG. 6B is a modification of FIG. 6A. FIG. 7A and FIG. 7B are views taken along a direction of an arrow D in FIG. 1 (as viewed in a Z direction), in which FIG. 7A is a diagram illustrating a state in which conductor portions are bent, and FIG. 7B is a modification of FIG. 7A. FIG. 8 is a modification of FIG. 2. FIG. 9 is a modification of FIG. 4.

A flexible busbar 1 according to the first embodiment illustrated in FIGS. 1 to 3 is a member that electrically connects a plurality of battery modules in a battery pack of an electric vehicle, for example, and includes a pair of terminal portions 5, an electric wire portion 3, and an insulating portion 7.

The pair of terminal portions 5 are conductive members to be connected to an external device (not illustrated) such as a battery module, and are conductive terminals or busbars made of Sn plated copper or the like. In FIGS. 1 and 2, plate-shaped terminals 5a and 5b are illustrated as the pair of terminal portions 5, but one or both of the terminals 5a and 5b may be replaced with busbars. When one or both of the terminals 5a and 5b are replaced with busbars, the busbars are provided with connection portions (not illustrated) to be electrically connected to external devices.

The electric wire portion 3 is a conductive member that electrically connects the pair of terminal portions 5, and includes a plurality of, here, two, conductor portions 3a and 3b that are stranded wires. The conductor portions 3a and 3b each have a linear outer shape, and a cross section perpendicular to the Y direction which is an axial direction of the line is circular as illustrated in FIG. 4. Furthermore, the conductor portions 3a and 3b extend in the Y direction which is the axial direction, and are arranged in parallel in a parallel direction (X direction) which is a direction orthogonal to the Y direction.

As illustrated in FIG. 2, ends of the conductor portions 3a and 3b on one side in the Y direction, that is, ends on one side in the axial direction are electrically connected to the terminal 5a, and ends on the other side in the Y direction are electrically connected to the terminal 5b. FIG. 2 illustrates a configuration in which the ends of the conductor portions 3a and 3b on one side are bundled together or similarly processed to form a single joint portion 9a, which is connected to the terminal 5a, and the ends on other side are bundled together or similarly processed to form a single joint portion 9b, which is connected to the terminal 5b. The joint portions 9a and 9b are electrically connected to the terminals 5a and 5b by known joining sections such as metal crimping, ultrasonic joining, or welding selected according to the materials and shapes of the conductor portions 3a and 3b and the terminals 5a and 5b. FIG. 5 illustrates an example in which a fusion portion 10 is formed by resistance welding on a contact surface between the terminal 5a and the joint portion 9a, thereby electrically connecting the terminal 5a and the conductor portions 3a, 3b via the fusion portion 10. However, since it is sufficient that the ends of the conductor portions 3a and 3b are electrically connected to the terminals 5a and 5b, the ends of the conductor portions 3a and 3b may be individually and electrically connected to the terminals 5a and 5b without being combined into one structure like the joint portions 9a and 9b.

The conductor portions 3a and 3b each have flexibility allowing the conductor portions 3a and 3b to be bent independently. Specifically, as illustrated in FIG. 4, at least intermediate portions between both ends of the conductor portions 3a and 3b are not joined together. Therefore, when an external force is applied to one of the terminals 5a and 5b in a state in which the other of the terminals 5a and 5b is fixed, the plurality of conductor portions 3a and 3b are bent at least in their intermediate portions between both ends, according to a direction and a magnitude of the applied external force.

For example, it is assumed that the terminals 5a and 5b of the flexible busbar 1 are connected to a pair of external terminals of an external device. In this case, a reference dimension which is a design distance between the terminal 5a and the terminal 5b should be substantially the same as a reference dimension which is a design distance between the pair of external terminals. However, when the dimensional tolerances of the terminals 5a and 5b and the conductor portions 3a and 3b constituting the flexible busbar 1 all accumulate in an upper limit direction and become longer than the reference dimension, the distance between the terminals 5a and 5b becomes longer than the distance between the pair of external terminals. In this case, in a state in which the terminal 5a is connected and fixed to one of the external terminals, the position of the terminal 5b may not align with the position of the other external terminal of the external device. When the positions are not aligned, in order to connect the terminal 5b to the other external terminal, it is necessary to align the position of the terminal 5b with the position of the other external terminal by pressing the terminal 5b toward the terminal 5a in the Y direction or performing similar actions. When an external force is applied to the terminal 5b in the Y direction by pressing the terminal 5b toward the terminal 5a or performing similar actions, the conductor portions 3a and 3b are bent in at least one of the Z direction and the X direction as illustrated in FIGS. 6A and 6B and FIGS. 7A and 7B. When the conductor portions 3a and 3b are bent, the terminal 5b moves in the Y direction toward the terminal 5a so that the distance in the Y direction between the terminal 5a and the terminal 5b is shortened, and thus the position of the terminal 5b can be aligned with the position of another external terminal. Even when an external force is applied to the terminal 5b in the X direction or the Z direction in a state in which the terminal 5a is fixed, the terminal 5b can be moved in the X direction or the Z direction by bending the conductor portions 3a and 3b in response to the external force. As described above, the flexible busbar 1 can adjust the distances between the terminal 5a and the terminal 5b in the X direction, the Y direction, and the Z direction by allowing the conductor portions 3a and 3b to be bent in response to an external force, and therefore the dimensional tolerance of the flexible busbar 1 can be absorbed by the conductor portions 3a and 3b.

In addition, since the electric wire portion 3 includes the two conductor portions 3a and 3b, a cross-sectional area of each of the conductor portions 3a and 3b can be reduced and a force required to bend the conductor portions 3a and 3b can be reduced as compared with a case in which a single conductor having the same cross-sectional area as the conductor portions 3a and 3b is used as the electric wire portion 3. Therefore, the flexible busbar 1 can be easily bent at the conductor portions 3a and 3b, which are bendable portions, regardless of the bending direction.

Furthermore, when an external force is applied to the pair of terminal portions 5 due to swinging of the external device or a similar action in a state in which the pair of terminal portions 5 are connected to the external terminals of the external device, the conductor portions 3a and 3b are bent in response to the external force, and thus stress applied to the pair of terminal portions 5 and the external terminals can be relaxed.

When the flexible busbar 1 is energized by passing a current between the terminals 5a and 5b or performing similar actions, the conductor portions 3a and 3b generate heat due to electric resistance, but a part of the heat is released from the surfaces of the conductor portions 3a and 3b to the outside of the conductor portions 3a and 3b. Here, since the conductor portions 3a and 3b are a plurality of, here, two stranded wires, the ratio of the surface area to the volume is larger than that of a single stranded wire or braided wire with the same total cross-sectional area perpendicular to the axial direction. Therefore, the conductor portions 3a and 3b are excellent in heat dissipation performance as compared with a single stranded wire or braided wire having the same cross-sectional area.

The conductor portions 3a and 3b can be made using bare electric wires such as well-known stranded wires made of copper or aluminum. Accordingly, it is possible to flexibly cope with the development of variations of the stranded wires, changes in the metal material and structure of the stranded wires, and the like. The cross-sectional area, number of parallel strands, wire diameter, stranding structure, number of stranding, and the like of the conductor portions 3a and 3b are appropriately designed according to a tolerance absorption amount, a cross-sectional area, and an arrangement space necessary for the conductor portions 3a and 3b. For example, when the total cross-sectional area of the conductor portions 3a and 3b is not changed, as the number of the conductor portions 3a and 3b is increased, the diameter per conductor portion can be reduced, and the height in the Z direction can be reduced. That is, the height of the flexible busbar 1 can be reduced. The smaller the diameter per strand of the conductor portions 3a and 3b, the more flexible the conductor portions 3a and 3b become, reducing the force required to bend the conductor portions 3a and 3b. Meanwhile, as the number of strands of the conductor portions 3a and 3b is reduced, the width in the X direction can be reduced. Furthermore, although a smaller number of strands of the conductor portions 3a and 3b increases the wire diameter per strand, the cost of the stranded wires decreases as the wire diameter increases, and therefore, reducing the number of strands of the conductor portions 3a and 3b can reduce the cost.

More specifically, FIG. 2 illustrates a case in which the electric wire portion 3 has the conductor portions 3a and 3b, that is, a case in which the number of strands of the stranded wire is two, but the number of strands of the stranded wire may be three or more, for example, four. In addition, when the length of the conductor portions 3a and 3b in the Y direction is longer than the reference dimension within a tolerance allowable range, the movement amount in the Y direction can be increased, and the excess length up to the tolerance upper limit can be absorbed by the bending of the conductor portions 3a and 3b, which is preferable. That is, the length of the conductor portions 3a and 3b in the Y direction is preferably longer than the reference dimension and shorter than the tolerance upper limit.

As illustrated in FIG. 4, the conductor portions 3a and 3b are arranged in parallel with at least their intermediate portions between both ends are separated from each other. In this configuration, there is a gap between the adjacent conductor portions 3a and 3b. Therefore, at the time when an external force is applied to the conductor portions 3a and 3b and the bending is started, the conductor portions 3a and 3b do not come into contact with the other adjacent conductor portions 3a and 3b, and thus bending is easier as compared with a case in which the conductor portions 3a and 3b are in contact with each other. However, the conductor portions 3a and 3b may be in contact with each other in the X direction which is the parallel direction. The reason is that even if the conductor portions 3a and 3b are in contact with each other, the contact is either linear or point-like, allowing the conductor portions 3a and 3b to be bent independently and having no significant impact on heat dissipation performance.

Although the pair of terminal portions 5 are separate members from the electric wire portion 3 in FIG. 2, the pair of terminal portions 5 may be integrated with the electric wire portion 3. Specifically, as illustrated in FIG. 8, the ends of the conductor portions 3a and 3b of the electric wire portion 3 may be joined by crimping or the like to form joint portions 9a and 9b, which are unified into a single wire, and the joint portions 9a and 9b may serve as the pair of terminal portions 5. In this case, fastening holes through which bolts or the like for fastening the pair of terminal portions 5 to the external device are inserted may be provided in the joint portions 9a and 9b.

Whether the pair of terminal portions 5 and the electric wire portion 3 are formed as separate members or integrated may be appropriately selected in consideration of respective advantages. For example, a configuration in which the pair of terminal portions 5 and the electric wire portion 3 are separate members is advantageous in that the terminals 5a and 5b can be made of rigid bodies, allowing for higher strength of the pair of terminal portions 5 as compared with a case in which the ends of the conductor portions 3a and 3b are joined by crimping or the like for integration. Meanwhile, a configuration in which the pair of terminal portions 5 are integrated with the electric wire portion 3 is advantageous in that no separate components are required for the terminals 5a and 5b, thereby reducing the number of components in the flexible busbar 1. Even when an external force is applied to the flexible busbar 1, this configuration is advantageous in that the pair of terminal portions 5 and the electric wire portion 3 are less likely to be separated from each other by the external force.

The insulating portion 7 illustrated in FIGS. 1 to 4 is a member for insulating the electric wire portion 3 from members other than the pair of terminal portions 5, and is an insulator such as resin surrounding the conductor portions 3a and 3b. The insulating portion 7 surrounds the conductor portions 3a and 3b such that the conductor portions 3a and 3b as the conductor portions 3a and 3b are allowed to be bent independently. The insulating portion 7 may have flexibility or may be a rigid body having no flexibility.

More specifically, the insulating portion 7 is a tubular protector or tube that collectively surrounds the conductor portions 3a and 3b of the electric wire portion 3, and has a dimension allowing the insulating portion 7 to surround the conductor portions 3a and 3b such that an inner periphery of the tube and outer peripheries of the conductor portions 3a and 3b are separated from each other. For example, as illustrated in FIGS. 3 and 4, the insulating portion 7 may be a rectangular tubular protector 7a (insulating portion) having a frame-like shape with a rectangular outer shape when viewed from the Y direction that is the axial direction of the electrical wire portion 3. In the protector 7a, two sides parallel to each other among four sides of the rectangle are parallel to a height direction which is a direction orthogonal to both the X direction which is the parallel direction and the Y direction which is the axial direction, here, the Z direction. In the protector 7a, the other two sides parallel to each other of the rectangle are parallel to a width direction which is the parallel direction (X direction). The term "rectangular tube" as used herein includes a rectangular tube having rounded corners and a rectangular tube having chamfered corners.

The protector 7a includes an upper protector 13a and a lower protector 13b. The upper protector 13a is a resin member with a gate-shaped outer shape when viewed from the Y direction, forming an upper half of the rectangular tube. The lower protector 13b is a resin member with a gate-shaped outer shape that is inverted vertically compared to the upper protector 13a when viewed from the Y direction, forming a lower half of the rectangular tube. In this configuration, the lower protector 13b is disposed below the upper protector 13a, and a lower end of the upper protector 13a and an upper end of the lower protector 13b are joined to each other to assemble the rectangular tubular protector 7a. Furthermore, it is preferable that the protector 7a satisfies at least one of a condition (first condition) that an inner height H is larger than a maximum height T of the electric wire portion 3 in the Z direction which is the height direction and a condition (second condition) that an inner width W is larger than a maximum width L of the electric wire portion 3 in the width direction which is the parallel direction (X direction). FIG. 4 illustrates a case in which both conditions (first and second conditions) are satisfied. The maximum width L as used herein is a distance between outermost ends P1 and P2 in the width direction of the electric wire portion 3.

In this configuration, when the conductor portions 3a and 3b are surrounded and insulated by the protector 7a, and an external force is applied to one of the pair of terminal portions 5 in a state in which the other is fixed, the conductor portions 3a and 3b are bent in a range within a space inside the protector 7a. Therefore, a bendable range of the conductor portions 3a and 3b can be defined by an inner dimension of the protector 7a serving as the insulating portion 7. In addition, even when the conductor portions 3a and 3b are bent, the bent portions do not protrude to the outside of the protector 7a, and thus there is no risk of the bent portions coming into contact with other devices arranged around the flexible busbar 1, and tolerances can be absorbed and stress can be relaxed without affecting other devices.

As the inner height H and the inner width W of the protector 7a increase, the bendable range of the conductor portions 3a and 3b increases. For example, when the protector 7a having an inner height H1 illustrated in FIG. 6A is compared with the protector 7a having an inner height H2 illustrated in FIG. 6B, the inner height H2 is larger than the inner height H1. Therefore, the conductor portion 3b illustrated in FIG. 6B has a wider bendable range in the Z direction than the conductor portion 3b illustrated in FIG. 6A. When the protector 7a having an inner width W1 illustrated in FIG. 7A is compared with the protector 7a having an inner width W2 illustrated in FIG. 7B, the inner width W2 is larger than the inner width W1. Therefore, the conductor portions 3a and 3b illustrated in FIG. 7B have a wider bendable range in the X direction than the conductor portions 3a and 3b illustrated in FIG. 7A. Meanwhile, as the inner height H and the inner width W of the protector 7a increase, the external dimensions of the insulating portion 7 increase. Therefore, the inner height H and the inner width W of the protector 7a may be appropriately set in view of a balance between a range in which the conductor portions 3a and 3b are to be bent and the external dimension allowed for the protector 7a according to an arrangement space.

In addition, since the insulating portion 7 surrounds the conductor portions 3a and 3b such that the conductor portions 3a and 3b are allowed to be bent, the insulating portion 7 is not fixed to the conductor portions 3a and 3b and the pair of terminal portions 5, and is fixed to, for example, an insulating resin such as a terminal cover (not illustrated) which surrounds and insulates the pair of terminal portions 5. When the flexible busbar 1 is manufactured, the insulating portion 7 may surround the conductor portions 3a and 3b after the terminals 5a and 5b are connected to the conductor portions 3a and 3b. Alternatively, the insulating portion 7 may surround the conductor portions 3a and 3b in advance before the terminals 5a and 5b are connected to the conductor portions 3a and 3b.

Although the insulating portion 7 illustrated in FIGS. 4 and 5 is the rectangular tubular protector 7a, the insulating portion 7 is not limited to the rectangular tubular protector 7a as long as the insulating portion 7 can surround and insulate the conductor portions 3a and 3b such that the conductor portions 3a and 3b can be independently bent. For example, the insulating portion 7 may be a cylindrical tube 7b (insulating portion) as illustrated in FIG. 9. The tube 7b has an annular cross-section perpendicular to the Y direction, which is the axial direction of the electric wire portion 3, and preferably satisfies at least one of a condition (third condition) that an inner diameter Dc is larger than the maximum height T of the electric wire portion 3 in the Z direction which is the height direction, and a condition (fourth condition) that the inner diameter Dc is larger than the maximum width L of the electric wire portion 3 in the width direction which is the parallel direction (X direction). FIG. 9 illustrates a case in which both conditions (third and fourth conditions) are satisfied. In this configuration, when the conductor portions 3a and 3b are surrounded and insulated by the tube 7b, and an external force is applied to one of the pair of terminal portions 5 in a state in which the other is fixed, the conductor portions 3a and 3b are bent in a range within a space inside the tube 7b. The term "circle" as used herein includes shapes such as ellipses whose inner diameter Dc is not constant. As the inner diameter Dc of the tube 7b increases, the bendable range of the conductor portions 3a and 3b increases, but an external dimension of the tube 7b increases. Therefore, the inner diameter Dc of the tube 7b may be appropriately set in view of a balance between a range in which the conductor portions 3a and 3b are to be bent and the external dimension allowed for the tube 7b according to an arrangement space.

In this configuration, when the conductor portions 3a and 3b are surrounded and insulated by the tube 7b, and an external force is applied to one of the pair of terminal portions 5 in a state in which the other is fixed, the conductor portions 3a and 3b are bent in a range within a space inside the tube 7b. Therefore, the bendable range of the conductor portions 3a and 3b can be defined by an inner dimension of the tube 7b. In addition, even when the conductor portions 3a and 3b are bent, the bent portions do not protrude to the outside of the tube 7b, and thus there is no risk of the bent portions coming into contact with other devices arranged around the flexible busbar 1, and tolerances can be absorbed and stress can be relaxed without affecting other devices.

Whether the insulating portion 7 is the protector 7a or the tube 7b may be appropriately selected in consideration of respective advantages. For example, a case in which the insulating portion 7 is the protector 7a is advantageous in that rigidity is easily imparted to the insulating portion 7 as compared with a case in which the insulating portion 7 is the tube 7b. Meanwhile, a case in which the insulating portion 7 is the tube 7b is advantageous in that flexibility is easily imparted to the insulating portion 7 as compared with the case in which the insulating portion 7 is the protector 7a. The configuration of the flexible busbar 1 according to the first embodiment has been described above.

As described above, the flexible busbar 1 according to the first embodiment includes the pair of terminal portions 5, the electric wire portion 3 including the conductor portions 3a and 3b that are arranged in parallel and independently bendable and connect the pair of terminal portions 5, and the insulating portion 7 surrounding the conductor portions 3a and 3b such that the conductor portions 3a and 3b are allowed to be bent independently. In this configuration, when an external force is applied to one of the pair of terminal portions 5 in a state in which the other is fixed, the conductor portions 3a and 3b are bent to absorb tolerances and relax stress, and heat generated by energization between the pair of terminal portions 5 is released from the surfaces of the conductor portions 3a and 3b. Therefore, the flexible busbar 1 can be easily bent at the conductor portions 3a and 3b, which are bendable portions, regardless of the bending direction, and has excellent heat dissipation performance.

In the flexible busbar 1 according to the first embodiment, the insulating portion 7 is the tubular protector 7a or the tube 7b that collectively surrounds the conductor portions 3a and 3b of the electric wire portion 3, and has a dimension allowing the insulating portion 7 to surround the conductor portions 3a and 3b such that the inner periphery of the tube and the outer peripheries of the conductor portions 3a and 3b are separated from each other. In this configuration, when the conductor portions 3a and 3b are surrounded and insulated by the protector 7a or the tube 7b, and an external force is applied to one of the pair of terminal portions 5 in a state in which the other is fixed, the conductor portions 3a and 3b are bent in a range within the space inside the protector 7a or the tube 7b. In this configuration, the bendable range of the conductor portions 3a and 3b can be defined by the inner dimension of the protector 7a or the tube 7b. Furthermore, in the flexible busbar 1 according to the first embodiment, even when the conductor portions 3a and 3b are bent, the bent portions do not protrude to the outside of the protector 7a or the tube 7b. Therefore, there is no risk of the bent portions coming into contact with other devices arranged around the flexible busbar 1, and tolerances can be absorbed and stress can be relaxed without affecting other devices.

In the flexible busbar 1 according to the first embodiment, the insulating portion 7 may be the rectangular tubular protector 7a. In this case, it is preferable that the protector 7a satisfies at least one of a condition that the inner height H of the insulating portion 7 is larger than the maximum height T of the electric wire portion 3 in the Z direction which is the height direction and a condition that the inner width W of the insulating portion 7 is larger than the maximum width L of the electric wire portion 3 in the width direction which is the parallel direction (X direction). In this configuration, when the conductor portions 3a and 3b are surrounded and insulated by the protector 7a, and an external force is applied to one of the pair of terminal portions 5 in a state in which the other is fixed, the conductor portions 3a and 3b are bent in a range within the space inside the protector 7a. This configuration is advantageous in that rigidity is easily imparted to the insulating portion 7 as compared with the case in which the insulating portion 7 is the tube 7b.

Meanwhile, in the flexible busbar 1 according to the first embodiment, the insulating portion 7 may be the cylindrical tube 7b. In this case, the insulating portion 7 preferably satisfies at least one of a condition that the inner diameter Dc of the insulating portion 7 is larger than the maximum height T of the electric wire portion 3 in the Z direction which is the height direction, and a condition that the inner diameter Dc of the insulating portion 7 is larger than the maximum width L of the electric wire portion 3 in the width direction which is the parallel direction (X direction). In this configuration, when the conductor portions 3a and 3b are surrounded and insulated by the tube 7b, and an external force is applied to one of the pair of terminal portions 5 in a state in which the other is fixed, the conductor portions 3a and 3b are bent in a range within a space inside the tube 7b. This configuration is advantageous in that flexibility is easily imparted to the insulating portion 7 as compared with the case in which the insulating portion 7 is the protector 7a.

In the flexible busbar 1 according to the first embodiment, the pair of terminal portions 5 may be integrated with the electric wire portion 3. In this configuration, the ends of the conductor portions 3a and 3b serve as the terminals 5a and 5b. Therefore, it is not necessary to separately prepare components for the terminals 5a and 5b, and the number of components of the flexible busbar 1 can be reduced. Even when an external force is applied to the flexible busbar 1, the pair of terminal portions 5 and the electric wire portion 3 are less likely to be separated from each other by the external force.

Furthermore, in the flexible busbar 1 according to the first embodiment, the conductor portions 3a and 3b may be arranged in parallel and separated from each other. In this configuration, there is a gap between the adjacent conductor portions 3a and 3b. Therefore, at the time when an external force is applied to the conductor portions 3a and 3b and the bending is started, the conductor portions 3a and 3b do not come into contact with the other adjacent conductor portions 3a and 3b, making it easier to bend the conductor portions 3a and 3b as compared with a case in which the conductor portions 3a and 3b are in contact with each other.

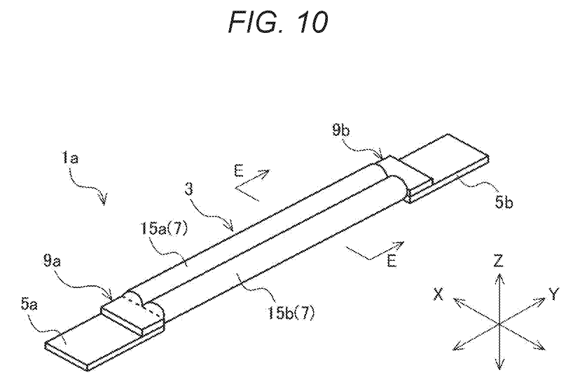

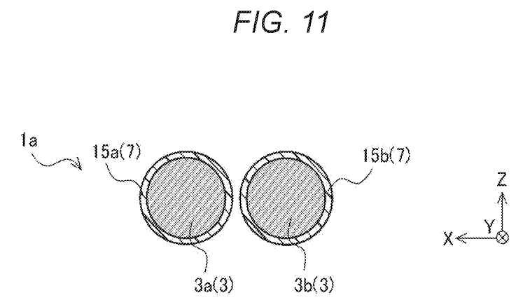

Next, a configuration of a flexible busbar according to a second embodiment will be described with reference to FIGS. 10 and 11. FIG. 10 is a perspective view illustrating the flexible busbar according to the second embodiment of the present disclosure. FIG. 11 is a cross-sectional view taken along line E-E in FIG. 10, in which illustration of individual wires constituting a stranded wire is omitted. In the second embodiment, the insulating portion 7 in the first embodiment is replaced with an insulating sheath. In the second embodiment, elements having the same functions as those in the first embodiment are given the same reference numerals, and differences from the first embodiment will be mainly described.

As illustrated in FIGS. 10 and 11, in a flexible busbar 1a according to the second embodiment, the insulating portion 7 is implemented by insulating sheaths 15a and 15b (insulating portions) made of resin or the like that individually surround and cover the conductor portions 3a and 3b of the electric wire portion 3. More specifically, a surface layer of the conductor portion 3a is covered with the insulating sheath 15a, and a surface layer of the conductor portion 3b is covered with the insulating sheath 15b. The flexible busbar 1a is not provided with a member such as the tubular protector 7a or the tube 7b that collectively surrounds the conductor portions 3a and 3b of the electric wire portion 3. In this configuration, the surface layers of the individual conductor portions 3a and 3b are covered with the insulating sheaths 15a and 15b, thereby insulating the conductor portions 3a and 3b. Further, since the insulating sheath 15a covering the conductor portion 3a and the insulating sheath 15b covering the conductor portion 3b are not joined to each other, the conductor portion 3a and the conductor portion 3b can be independently bent even when the insulating portion 7 is implemented by the insulating sheaths 15a and 15b.

Whether the insulating portion 7 collectively surrounds the conductor portions 3a and 3b as in the first embodiment or the insulating portion 7 individually surrounds the conductor portions 3a and 3b as in the second embodiment may be appropriately selected in consideration of respective advantages.

For example, when the insulating portion 7 is configured to collectively surround the conductor portions 3a and 3b as in the first embodiment, the conductor portions 3a and 3b and the insulating portion 7 can be separated from each other. Therefore, it is advantageous in that heat generated when the conductor portions 3a and 3b and the terminals 5a and 5b are joined by resistance welding or the like is less likely to be transferred to the insulating portion 7, and the insulating portion 7 is less likely to be affected by the heat when joining. Meanwhile, when the insulating portion 7 is configured to individually surround the conductor portions 3a and 3b as in the second embodiment, the conductor portions 3a and 3b can be independently bent without providing a space between the insulating portion 7 and the conductor portions 3a and 3b. Therefore, it is advantageous in that the flexible busbar 1a can be downsized as compared with a configuration in which the conductor portions 3a and 3b are collectively surrounded. The configuration of the flexible busbar 1a according to the second embodiment has been described above.

As described above, the flexible busbar 1a according to the second embodiment includes the pair of terminal portions 5, the electric wire portion 3 including the conductor portions 3a and 3b that are arranged in parallel and independently bendable and connect the pair of terminal portions 5, and the insulating portion 7 surrounding the conductor portions 3a and 3b such that the conductor portions 3a and 3b are allowed to be bent independently. Therefore, the same effect as that of the first embodiment is achieved.

In the flexible busbar 1a according to the second embodiment, the insulating portion 7 is implemented by the insulating sheaths 15a and 15b that individually surround and cover the conductor portions 3a and 3b of the electric wire portion 3. In this configuration, the surface layers of the individual conductor portions 3a and 3b are covered with the insulating sheaths 15a and 15b, thereby insulating the conductor portions 3a and 3b. Therefore, the flexible busbar 1a can be downsized as compared with the first embodiment.

Although the present disclosure has been described above based on the embodiments, the present disclosure is not limited to the above embodiments, and modifications may be made without departing from the gist of the present disclosure and other techniques may be appropriately combined if possible. Furthermore, public or well-known techniques may be combined if possible.

For example, in the above embodiments, the conductor portions 3a and 3b are stranded wires having a circular cross section perpendicular to the Y direction which is the axial direction, but the conductor portions 3a and 3b are not limited to stranded wires having a circular cross section as long as the conductor portions 3a and 3b are conductive wires. For example, the conductor portions 3a and 3b may be stranded wires obtained by rolling stranded wires having a circular cross section to make the cross section perpendicular to the axial direction elliptical, or the conductor portions 3a and 3b may be flat braided wires instead of stranded wires.

What is claimed is:

1. A flexible busbar comprising:
a pair of terminal portions that are conductive terminals or busbars;
an electric wire portion including a plurality of conductor portions electrically connecting between the pair of terminal portions, the plurality of conductor portions being arranged in parallel in a parallel direction which is a direction orthogonal to an axial direction of the electric wire portion and having flexibility allowing the conductor portion to be bent independently; and
an insulating portion that is an insulator surrounding the plurality of conductor portions of the electric wire portion such that each of the plurality of conductor portions is allowed to be bent independently.

2. The flexible busbar according to claim 1, wherein
the insulating portion is a tubular protector or tube that collectively surrounds the plurality of conductor portions of the electric wire portion, and has a dimension allowing the insulating portion to surround the conductor portions such that an inner periphery of the tube and an outer periphery of the conductor portions are separated from each other.

3. The flexible busbar according to claim 2, wherein
the insulating portion is a rectangular tubular protector, and
the insulating portion satisfies at least one of
a first condition that an inner height of the protector is larger than a maximum height of the electric wire portion in a height direction which is a direction orthogonal to both the parallel direction and the axial direction, and
a second condition that an inner width of the protector is larger than a maximum width of the electric wire portion in a width direction which is the parallel direction.

4. The flexible busbar according to claim 2, wherein
the insulating portion is a cylindrical tube, and
the insulating portion satisfies at least one of
a third condition that an inner diameter of the tube is larger than a maximum height of the electric wire portion in a height direction which is a direction orthogonal to both the parallel direction and the axial direction, and
a fourth condition that the inner diameter of the tube is larger than a maximum width of the electric wire portion in a width direction which is the parallel direction.

5. The flexible busbar according to claim 1, wherein
the insulating portion is an insulating sheath that individually surrounds and covers the plurality of conductor portions of the electric wire portion.

6. The flexible busbar according to claim 1, wherein
the pair of terminal portions are integrated with the electric wire portion.

7. The flexible busbar according to claim 1, wherein
the plurality of conductor portions are located in parallel and separated from each other.
